(19) United States
(12) Patent Application Publication
(10) Pub. No.: US 2016/0046780 A1
(43) Pub. Date: Feb. 18, 2016

(54) FLEXIBLE FOAMS HAVING AN ABRASIVE SURFACE

(71) Applicant: BASF SE, Ludwigshafen (DE)

(72) Inventors: Matthias SCHADE, Ludwigshafen (DE); Rebekka VON BENTEN, Ludwigshafen (DE); Günter SCHERR, Ludwigshafen (DE)

(73) Assignee: BASF SE, Ludwigshafen (DE)

(21) Appl. No.: 14/780,215

(22) PCT Filed: Mar. 18, 2014
(86) PCT No.: PCT/EP2014/055368

§ 371 Date: Sep. 25, 2015

(30) Foreign Application Priority Data
Mar. 28, 2013 (EP) 13161530.4

(51) Int. Cl. C08J 9/36; B05D 3/00

(52) U.S. Cl. CPC C08J 9/365; B05D 3/007; C08J 2461/28; C08J 2375/04; C08J 2433/20; C08J 2475/04

(57) ABSTRACT

The invention relates to flexible foams with a flexible, abrasive surface which comprise 1 to 90% by weight of a mixture, based on the uncoated substrate, which comprises the condensation product of 99.985 to 20% by weight of at least one precondensate of a heat-curable resin, 0 to 10% by weight of a polymeric thickener selected from the group consisting of biopolymers, associative thickeners and/or completely synthetic thickeners, 0.01 to 10% by weight of a curing agent, 0 to 10% by weight of surface-active substances or surfactants, 0 to 15% by weight of dyes, pigments, or mixtures thereof and 0 to 75% by weight of water, where this mixture comprises 10 to 70% by weight of one or more binders based on the above mixture, from the group of polyacrylates, polymethacrylates, polyacrylonitriles, copolymers of acrylic acid esters and acrylonitrile, styrene and acrylonitrile, acrylic acid esters and styrene and acrylonitrile, acrylonitrile and butadiene and styrene, polyurethanes, melamine-formaldehyde resins, phenol-formaldehyde resins, urea-formaldehyde resins, melamine-urea-formaldehyde resins, melamine-urea-phenol-formaldehyde resins, urea-glyoxal resins.

The invention relates to flexible foams with a flexible abrasive surface and to their use as abrasive foams for machine and manual floor cleaning.

The coating of a flexible foam with an abrasive layer has been known for a long time. These foams are used for example in cleaning and polishing sponges. In order to achieve the desired abrasive effect, the foams are equipped with abrasive particles on at least one surface.

WO-A-90/11870 discloses the adhesion of abrasive particles using a flexible binder to the surface of a flexible foam.

WO-A-99/24223 discloses flexible, abrasive foams, the surface of which has been provided with a hard, nonflexible coating comprising abrasive particles, and a process for the coating thereof

The known flexible, abrasive foams have the disadvantage that they scratch the surfaces to be cleaned, as well as of the poor adhesion of the abrasive particles to the foams.

The object of the present invention was therefore to overcome the aforementioned disadvantages, in particular to improve the scratching of the surfaces to be cleaned.

Accordingly, new and improved flexible foams with a flexible, abrasive surface which comprise 1 to 90% by weight of a mixture, based on the uncoated substrate, which comprises the condensation product of 99.985 to 20% by weight of at least one precondensate of a heat-curable resin, 0 to 10% by weight of a polymeric thickener selected from the group consisting of biopolymers, associative thickeners and/or completely synthetic thickeners, 0.01 to 10% by weight of a curing agent, 0 to 10% by weight of surface-active substances or surfactants, 0 to 15% by weight of dyes, pigments, or mixtures thereof and 0 to 75% by weight of water, have been found, wherein this mixture comprises 10 to 70% by weight of one or more binders based on the above mixture, from the group of polyacrylates, polymethacrylates, polyacrylonitriles, copolymers of acrylic acid esters and acrylonitrile, styrene and acrylonitrile, acrylic acid esters and styrene and acrylonitrile, acrylonitrile and butadiene and styrene, polyurethanes, melamine-formaldehyde resins, phenol-formaldehyde resins, urea-formaldehyde resins, melamine-urea-formaldehyde resins, melamine-urea-phenol-formaldehyde resins, urea-glyoxal resins or mixtures thereof, as have processes for the production thereof.

The flexible foams according to the invention with a flexible, abrasive surface comprise 1 to 95% by weight, preferably 2 to 90% by weight, particularly preferably 5 to 85% by weight, of a mixture which comprises, in particular consists of, the condensation product of at least one precondensate of a heat-curable resin, a curing agent and a binder. Possible further components of the mixture may be thickeners, surfactants, dyes, pigments or mixtures thereof.

These mixtures generally comprise
a) 99.985 to 20% by weight, preferably 80 to 20% by weight, particularly preferably 70 to 20% by weight, of a precondensate of a heat-curable resin,
b) 0 to 10% by weight, preferably 0 to 5% by weight, particularly preferably 0 to 5% by weight, of a polymeric thickener from the group consisting of biopolymers, associative thickeners and/or completely synthetic thickeners or mixtures thereof,
c) 0.01 to 10% by weight, preferably 0.1 to 10% by weight, particularly preferably 0.5 to 10% by weight, of one or more curing agents,
d) 0 to 10% by weight, preferably 0.001 to 5% by weight, particularly preferably 0.001 to 2.5% by weight, of one or more surface-active substances, surfactants or mixtures thereof,
e) 0 to 15% by weight, preferably 0 to 10% by weight, particularly preferably 0 to 5% by weight, of dyes, pigments or mixtures thereof,
f) 0 to 75% by weight, preferably 0 to 70% by weight, particularly preferably 0 to 65% by weight, of water,
   and 10 to 70% by weight, preferably 10 to 60% by weight, particularly preferably 10 to 50% by weight, of a binder based on the above mixture.

Within the context of this invention, abrasive surfaces means that these surfaces, when moved over another surface, exert a rubbing and/or scouring effect.

Suitable flexible foams are polystyrene, polyvinyl chloride, polyurethane, polyamide, polyester, polyolefin or cellulose foams, preferably polystyrene, polyurethane, polyester or polyolefin foams, particularly preferably polyurethane, polyester or polyolefin foams, in particular polyurethane foams.

In one preferred embodiment, the foam is constructed on the basis of polystyrene. Polystyrene is used here as a collective term and comprises homo- and copolymers of vinylaromatic monomers. Suitable monomers are styrene, α-methylstyrene, p-methylstyrene, ethylstyrene, tert-butylstyrene, vinylstyrene, vinyltoluene, 1,2-diphenylethylene, 1,1-diphenylethylene or mixtures thereof. A preferred monomer is styrene.

The production of polystyrene foams as particle foams or extrusion foams is known. For particle foams, firstly blowing-agent-containing, expandable polystyrene (EPS) is produced, which can take place according to the suspension process (polymerization in the presence of blowing agents), the impregnation process (impregnation of blowing-agent-free polystyrene particles with the blowing agent under pressure in a heated suspension, where the blowing agent diffuses into the softened particles, and cooling the suspension under pressure) or the extrusion process (mixing the blowing agent into a polystyrene melt by means of an extruder, discharging the blowing-agent-containing melt under pressure, then underwater pressurized granulation). The EPS particles are then foamed by pre- and fully-foaming to give the polystyrene foam.

Extrusion foams made of polystyrene (XPS) are produced by mixing the blowing agent into a polystyrene melt using an extruder, where the blowing-agent-containing melt escapes directly into the surrounding area and is not discharged under pressure. Upon emerging from the extrusion die, the melt foams with solidification.

In a further preferred embodiment, the foam is constructed on the basis of polyvinyl chloride. Of suitability as polyvinyl chloride (PVC) are, for example, the homopolymers rigid-PVC, obtainable by emulsion, suspension or bulk polymerization of vinyl chloride, and also plasticizer-containing flexible PVC, and PVC pastes. Of suitability as vinyl chloride copolymers are those with vinyl acetate (VCVAC), with ethylene (VCE), with vinylidene chloride (VCVDC), with methyl acrylate (VCMA) or octyl acrylate, with methyl methacrylate (VCMMA), with maleic acid or maleic anhydride (VCMAH), with maleimide (VCMAI) or with acrylonitrile. Chlorinated PVC (C-PVC) is also suitable. Polyvinyl chloride also comprises polyvinylidene chloride (PVDC), i.e. copolymers of vinylidene chloride and vinyl chloride.

In a further preferred embodiment, the foam is constructed on the basis of polyaddition products of isocyanates. Polyurethanes are a preferred embodiment of the polyaddition products based on isocyanate. Suitable polyurethanes can also comprise other linkages, in particular, isocyanurate and/or urea linkages. Flexible, semi-rigid or rigid, as well as thermoplastic or crosslinked polyurethane types are contemplated as polymer of the foam.

The production of polyurethanes is described multifariously and usually takes place by reacting isocyanates I) with compounds II) that are reactive towards isocyanates under generally known conditions. Preferably, the reaction is carried out in the presence of catalysts III) and usually in the presence of auxiliaries IV). If they are foamed polyurethanes—which is preferred—then these are produced in the presence of customary blowing agents V) or according to known methods for producing polyurethane foams.

Suitable isocyanates are for example 2,2′-, 2,4′- and/or 4,4′-diphenylmethane diisocyanate (MDI), 1,5-naphthalene diisocyanate (NDI), 2,4- and/or 2,6-tolylene diisocyanate (TDI), 3,3′-dimethyldiphenyl diisocyanate, 1,2-diphenylethane diisocyanate and/or p-phenylene diisocyanate (PPDI), tri-, tetra-, penta-, hexa-, hepta- and/or octamethylene diisocyanate, 2-methylpentamethylene-1,5-diisocyanate, 2-ethylbutylene-1,4-diisocyanate, pentamethylene-1,5-diisocyanate, butylene-1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), 1,4-cyclohexane diisocyanate, 1-methyl-2,4- and/or −2,6-cyclohexane diisocyanate and/or 4,4′-, 2,4′- and/or 2,2′-dicyclohexylmethane diisocyanate.

Preference is given to using aromatic diisocyanates, in particular 2,4- and/or 2,6-tolylene diisocyanate (TDI), 2,2′-, 2,4′- and/or 4,4′-diphenylmethane diisocyanate (MDI), 1,5-naphthalene diisocyanate (NDI) and paraphenylene diisocyanate (PPDI). Particular preference is given to using isocyanates based on TDI or based on MDI. Oligomeric, polynuclear aromatic isocyanates based on MDI are likewise contemplated.

Examples of compounds II) that are reactive towards isocyanates that can be used are generally known compounds with a molecular weight of from 60 to 10 000 and a functionality towards isocyanates of from 1 to 8, preferably from 2 to 6. Suitable compounds II) are for example polyols, in particular those with a molecular weight of from 500 to 10 000, e.g. polyether polyols, polyester polyols, polyether polyester polyols, and/or diols, triols and/or polyols with molecular weights of less than 500.

Catalysts III) that can be used for producing the polyurethanes are optionally generally known compounds which increase the rate of the reaction of isocyanates with the compounds that are reactive towards isocyanates, where preferably an overall catalyst content of from 0.001 to 15% by weight, in particular 0.05 to 6% by weight, based on the weight of the compounds II) that are reactive towards isocyanates used in total, is used, for example tertiary amines and/or metal salts, for example inorganic and/or organic compounds of iron, lead, zinc and/or tin in customary oxidation states of the metal.

Auxiliaries IV) that can be used are optionally customary substances. Examples include surface-active substances, fillers, dyes, pigments, flame retardants, hydrolysis protectants, fungistatically and bacteriostatically acting substances, and UV stabilizers and antioxidants.

Details on polyurethanes, polyisocyanurates and polyureas can be found by the person skilled in the art in the Kunststoff-Handbuch [Plastics Handbook], volume 7, 3rd edition, “Polyurethane” [Polyurethanes], Hanser Verlag, Munich 1993.

### Component a)

Suitable precondensates of a heat-curable resin are melamine/formaldehyde precondensates with a molar ratio of melamine to formaldehyde of from 1:1 to 1:4, preferably from 1:1 to 1:3, particularly preferably from 1:1 to 1:2, examples including the Kauramin® impregnating resins from BASF SE, methanol-etherified melamine/formaldehyde precondensates with a molar ratio of melamines to formaldehyde of from 1:1 to 1:6, preferably from 1:1 to 1:5.5, particularly preferably from 1:1 to 1:5, examples including the Luwipal® coating crosslinkers from BASF SE, urea/formaldehyde precondensates with a molar ratio of urea to formaldehyde of from 1:0.5 to 1:5, preferably from 1:1 to 1:4, particularly preferably from 1:1 to 1:2, examples including the Kaurit® glues from BASF SE, urea/glyoxal precondensates such as the Fixapret® brands from BASF SE, melamine/urea/formaldehyde precondensates such as some Kauramin® or Kaurit® glues from BASF SE, melamine/urea/phenol/formaldehyde precondensates and phenol/formaldehyde precondensates, preferably melamine/formaldehyde precondensates with a molar ratio of melamine to formaldehyde of from 1:1 to 1:4, preferably from 1:1 to 1:3, particularly preferably from 1:1 to 1:2, methanol-etherified melamine/formaldehyde precondensates with a molar ratio of melamines to formaldehyde of from 1:1 to 1:6, preferably from 1:1 to 1:5.5, particularly preferably from 1:1 to 1:5, urea/glyoxal precondensates, melamine/urea/formaldehyde precondensates or urea/formaldehyde precondensates, particularly preferably melamine/formaldehyde precondensates with a molar ratio of melamine to formaldehyde of from 1:1 to 1:4, preferably from 1:1 to 1:3, particularly preferably from 1:1 to 1:2, methanol-etherified melamine/formaldehyde precondensates with a molar ratio of melamines to formaldehyde of from 1:1 to 1:6, preferably from 1:1 to 1:5.5, particularly preferably from 1:1 to 1:5, melamine/urea/formaldehyde precondensates or urea/formaldehyde condensates.

Preference is given to using a precondensate of melamine and formaldehyde in which the molar ratio of formaldehyde to melamine is less than 4:1. As heat-curable resin, preference is given to using a precondensate of melamine and formaldehyde in which the molar ratio of formaldehyde to melamine is 1:1 to 3:1, particularly preferably 1:1 to 2:1. Melamine/formaldehyde condensation products can comprise, besides melamine, 0.01 to 50% by weight, preferably 0.1 to 20% by weight, of “other thermoset formers” (as described below) and, besides formaldehyde, 0.01 to 50% by weight, preferably 0.1 to 20% by weight, of “other aldehydes” (as described below) in condensed-in form.

Suitable “other thermoset formers” are for example alkyl- and aryl-substituted melamine, urea, urethanes, carboxamides, dicyandiamide, guanidine, sulfurylamide, sulfonamides, aliphatic amines, glycols, phenol and phenol derivatives.

“Other aldehydes” which can be used, for example, for the partial replacement of the formaldehyde in the condensates, are acetaldehyde, propionaldehyde, isobutyraldehyde, n-butyraldehyde, trimethylolacetaldehyde, acrolein, benzaldehyde, furfural, glyoxal, glutaraldehyde, phthalaldehyde and terephthalaldehyde.

The precondensates can optionally be etherified with at least one alcohol. Examples thereof are monohydric C₁- to C₁₈-alcohols such as methanol, ethanol, isopropanol, n-propanol, n-butanol, sec-butanol, isobutanol, n-pentanol, cyclopentanol, n-hexanol, cyclohexanol, n-octanol, decanol, palmityl alcohol and stearyl alcohol, polyhydric alcohols such as glycol, diethylene glycol, glycerol, butanediol-1,4, hexanediol-1,6, polyethylene glycols with 3 to 20 ethylene oxide units, unilaterally terminally capped glycols and polyalkylene glycols, propylene glycol-1,2, propylene glycol-1,3, polypropylene glycols, pentaerythritol and trimethylolpropane.

The production of heat-curable resins belongs to the prior art, cf. Ullmann's Encyclopedia of Industrial Chemistry, sixth completely revised edition, Wiley-VCH Verlag GmbH Co. KGaA, Weinheim, “Amino Resins”, vol. 2, pages 537 to 565 (2003).

As a rule, the starting point is an aqueous solution or dispersion of a precondensate, preferably of melamine and formaldehyde. The solids concentration is generally 5 to 95% by weight, preferably 10 to 70% by weight.

### Component b)

Suitable polymeric thickeners are biopolymers, associative thickeners, completely synthetic thickeners or mixtures thereof, preferably biopolymers, completely synthetic thickeners or mixtures thereof, particularly preferably biopolymers.

Suitable biopolymers are polysaccharides such as starch, guar seed flour, carob seed flour, agar agar, pectins, gum Arabic, xanthan, proteins such as gelatin, casein or mixtures thereof, preferably polysaccharides such as starch, guar seed flour, carob seed flour, agar agar, pectins, gum Arabic, xanthan, or proteins such as gelatin, casein or mixtures thereof, particularly preferably polysaccharides such as starch, guar seed flour, carob seed flour, agar agar, pectins, gum Arabic, xanthan or mixtures thereof.

Suitable associative thickeners are modified celluloses such as methylcellulose (MC), hydroxyethylcellulose (HEC), hydroxypropylmethylcellulose (HPMC), hydroxypropylcellulose (HPC) and ethylhydroxyethylcellulose (EHEC), modified starches such as hydroxyethyl starch or hydroxypropyl starch, or mixtures thereof, preferably modified celluloses such as methylcellulose (MC), hydroxyethylcellulose (HEC), hydroxypropylmethylcellulose (HPMC), hydroxypropylcellulose (HPC), ethylhydroxyethylcellulose (EHEC) or mixtures thereof.

Suitable completely synthetic thickeners are, for example, polyvinyl alcohols, polyacrylamides, polyvinylpyrrolidone, polyethylene glycols or mixtures thereof.

### Component c)

Suitable curing agents are those which catalyze the further condensation of the heat-curable resins, such as acids or salts thereof, and also aqueous solutions of these salts.

Suitable acids are inorganic acids such as HCl, HBr, HI, H₂SO₃, H₂SO₄, phosphoric acid, polyphosphoric acid, nitric acid, sulfonic acids, for example p-toluenesulfonic acid, methanesulfonic acid, trifluoromethanesulfonic acid, nonafluorobutanesulfonic acid, carboxylic acids such as C₁- to C₈-carboxylic acids, for example formic acid, acetic acid, propionic acid or mixtures thereof, preferably inorganic acids such as HCl, H₂SO₃, H₂SO₄, phosphoric acid, polyphosphoric acid, nitric acid, sulfonic acids such as p-toluenesulfonic acid, methanesulfonic acid, carboxylic acids such as C₁- to C₈-carboxylic acids, for example formic acid, acetic acid, particularly preferably inorganic acids such as H₂SO₄, phosphoric acid, nitric acid, sulfonic acids such as p-toluenesulfonic acid, methanesulfonic acid, carboxylic acids such as formic acid, acetic acid.

Suitable salts are halides, sulfites, sulfates, hydrogensulfates, carbonates, hydrogencarbonates, nitrites, nitrates, sulfonates, salts of carboxylic acids such as formates, acetates, propionates, preferably sulfites, carbonates, nitrates, sulfonates, salts of carboxylic acids such as formates, acetates, propionates, particularly preferably sulfites, nitrates, sulfonates, salts of carboxylic acids such as formates, acetates, propionates, of protonated, primary, secondary and tertiary aliphatic amines, alkanolamines, cyclic, aromatic amines such as C₁- to C₈-amines, isopropylamine, 2-ethylhexylamine, di(2-ethylhexyl)amine, diethylamine, dipropylamine, dibutylamine, diisopropylamine, tert-butylamine, triethylamine, tripropylamine, triisopropylamine, tributylamine, monoethanolamine, morpholine, piperidine, pyridine, and also ammonia, preferably protonated primary, secondary and tertiary aliphatic amines, alkanolamines, cyclic amines, cyclic aromatic amines, and ammonia, particularly preferably protonated alkanolamines, cyclic amines, and ammonia or mixtures thereof.

Salts which may be mentioned are in particular: ammonium chloride, ammonium bromide, ammonium iodide, ammonium sulfate, ammonium sulfite, ammonium hydrogensulfate, ammonium methanesulfonate, ammonium p-toluenesulfonate, ammonium trifluoromethanesulfonate, ammonium nonafluorobutanesulfonate, ammonium phosphate, ammonium nitrate, ammonium formate, ammonium acetate, morpholinium chloride, morpholinium bromide, morpholinium iodide, morpholinium sulfate, morpholinium sulfite, morpholinium hydrogensulfate, morpholinium methanesulfonate, morpholinium p-toluenesulfonate, morpholinium trifluoromethanesulfonate, morpholinium nonafluorobutanesulfonate, morpholinium phosphate, morpholinium nitrate, morpholinium formate, morpholinium acetate, monoethanolammonium chloride, monoethanolammonium bromide, monoethanolammonium iodide, monoethanolammonium sulfate, monoethanolammonium sulfite, monoethanolammonium hydrogensulfate, monoethanolammonium methanesulfonate, monoethanolammonium p-toluenesulfonate, monoethanolammonium trifluoromethanesulfonate, monoethanolammonium nonafluorobutanesulfonate, monoethanolammonium phosphate, monoethanolammonium nitrate, monoethanolammonium formate, monoethanolammonium acetate or mixtures thereof.

The salts are very particularly preferably used in the form of their aqueous solutions. In this connection, aqueous solutions are understood as meaning dilute, saturated, supersaturated and also partially precipitated solutions, and saturated solutions with a solids content of salt that is no longer soluble.

In special cases, the curing agents according to the invention specified for the condensation can also be applied separately to the flat substrate.

The amounts used of the curing agents according to the invention are generally 0.01 to 10% by weight, preferably 0.1 to 10% by weight, particularly preferably 0.5 to 10% by weight, based on the mixture.

### Component d)

Suitable surfactants are, for example, all surface-active agents. Examples of suitable nonionic surface-active substances are ethoxylated mono-, di- and trialkyiphenols (degree of ethoxylation: 3 to 50, alkyl radical: C₃-C₁₂) and ethoxylated fatty alcohols (degree of ethoxylation: 3 to 80; alkyl radical: C₈-C₃₆). Examples thereof are the Lutensol® brands from BASF SE or the Triton® brands from Union Carbide. Particular preference is given to ethoxylated linear fatty alcohols of the general formula

n-CₓH₂ₓ₊₁—O(CH₂CH₂O)_{y}—H,

where x is integers in the range from 10 to 24, preferably in the range from 12 to 20. The variable y is preferably integers in the range from 5 to 50, particularly preferably 8 to 40. Ethoxylated linear fatty alcohols are usually in the form of a mixture of different ethoxylated fatty alcohols with a different degree of ethoxylation. Within the context of the present invention, the variable y is the average value (number average). Suitable nonionic surface-active substances are also copolymers, in particular block copolymers of ethylene oxide and at least one C₃-C₁₀ alkylene oxide, e.g. triblock copolymers of the formula

RO(CH₂CH₂O)_{y1}—(BO)_{y2}-(A-O)ₘ—(B′O)_{y3}—(CH₂CH₂O)_{y4}R′,

where m is 0 or 1, A is a radical derived from an aliphatic, cycloaliphatic or aromatic diol, e.g. ethane-1,2-diyl, propane-1,3-diyl, butane-1,4-diyl, cyclohexane-1,4-diyl, cyclohexane-1,2-diyl or bis(cyclohexyl)methane-4,4′-diyl, B and B′, independently of one another, are propane-1,2-diyl, butane-1,2-diyl or phenylethenyl independently of one another a number from 2 to 100 and y2, y3 independently of one another are a number from 2 to 100, where the sum y1+y2+y3+y4 is preferably in the range from 20 to 400, which corresponds to a number-average molecular weight in the range from 1000 to 20 000. Preferably, A is ethane-1,2-diyl, propane-1,3-diyl or butane-1,4-diyl. B is preferably propane-1,2-diyl.

Suitable surface-active substances are furthermore polyalkylene glycols substituted with fluorine such as, for example, Zonyl® or Capstone® (DuPont).

Apart from the nonionic surfactants, also anionic and cationic surfactants are contemplated as surface-active substances. They can be used alone or as a mixture. A prerequisite for this, however, is that they are compatible with one another, i.e. do not produce any sediments with one another. This prerequisite is applicable, for example, for mixtures from one of each compound class, and also for mixtures of nonionic and anionic surfactants and mixtures of nonionic and cationic surfactants. Examples of suitable anionic surface-active agents are sodium lauryl sulfate, sodium dodecyl sulfate, sodium hexadecyl sulfate and sodium dioctyl sulfosuccinate. Furthermore, it is also possible to use esters of phosphoric acid or of phosphorous acid, and aliphatic or aromatic carboxylic acids as anionic emulsifiers.

Examples of cationic surfactants are quaternary alkylammonium salts, alkylbenzylammonium salts, such as dimethyl-C₁₂-C₁₈-alkylbenzylammonium chlorides, primary, secondary and tertiary fatty amine salts, quaternary amidoamine compounds, alkylpyridinium salts, alkylimidazolinium salts and alkyloxazolinium salts.

Customary emulsifiers are described in detail in the literature, see, for example, M. Ash, I. Ash, Handbook of Industrial Surfactants, third edition, Synapse Information Resources Inc.

The aqueous solution or dispersion can comprise one or more surface-active substances or surfactants in amounts of from 0 to 10% by weight, preferably 0.001 to 5% by weight, particularly preferably 0.001 to 2.5% by weight.

### Component e)

As well as the aforementioned customary additives such as thickeners, curing agents and surfactants, or instead of the aforementioned customary additives, the flexible foams according to the invention can also comprise dyes or pigments, preferably in an amount in the range from 0 to 15% by weight, preferably 0 to 10% by weight, particularly preferably 0 to 5% by weight, in particular 0.01 to 3% by weight, very particularly preferably 0.01 to 1% by weight.

Suitable dyes or pigments are inorganic and organic dyes or pigments, such as azo pigments and dyes, and polycyclic pigments, particularly copper phthalocyanine, indanthrene, polychlorocopper phthalocyanine, perylenes.

### Component f)

Water can be added in amounts of from 0 to 75% by weight or 0 to 79.985% by weight, preferably 0 to 70% by weight, particularly preferably 0 to 65% by weight, in addition to the water present in the aqueous components used.

Suitable binders are polyacrylates, polymethacrylates, polyacrylonitriles, and copolymers of acrylic acid esters and acrylonitrile, styrene and acrylonitrile, acrylic acid esters and styrene and acrylonitrile, acrylonitrile and butadiene and styrene, polyurethanes, melamine-formaldehyde resins, phenol-formaldehyde resins, urea-formaldehyde resins, melamine-urea-formaldehyde resins, melamine-urea-phenol-formaldehyde resins, urea-glyoxal resins or mixtures thereof, preferably aqueous binders of polyacrylates, polymethacrylates, polyacrylonitriles, and copolymers of acrylic acid esters and acrylonitrile, styrene and acrylonitrile, acrylic acid esters and styrene and acrylonitrile, acrylonitrile and butadiene and styrene, polyurethanes, melamine-formaldehyde resins, phenol-formaldehyde resins, urea-formaldehyde resins, melamine-urea-formaldehyde resins, melamine-urea-phenol-formaldehyde resins, urea-glyoxal resins or mixtures thereof, particularly preferably aqueous binders of polyacrylates, polymethacrylates, polyacrylonitriles, and copolymers of acrylic acid esters and acrylonitrile, styrene and acrylonitrile, acryl acid esters and styrene and acrylonitrile, acrylonitrile and butadiene and styrene, polyurethanes, melamine-formaldehyde resins, melamine-urea-formaldehyde resins or mixtures thereof, in particular aqueous binders of polyacrylates, polymethacrylates, polyacrylonitriles, and copolymers of acrylic acid esters and acrylonitrile, styrene and acrylonitrile, acryl acid esters and styrene and acrylonitrile, acrylonitrile and butadiene and styrene, polyurethanes, melamine-formaldehyde resins, melamine-urea-formaldehyde resins or mixtures thereof.

Polyacrylates, polymethacrylates, polyacrylonitriles, and copolymers of acrylic acid esters and acrylonitrile, styrene and acrylonitrile, acrylic acid esters and styrene and acrylonitrile, acrylonitrile and butadiene and styrene can be obtained by free-radical polymerization of ethylenically unsaturated compounds (monomers) according to generally known processes, as are known for example from Vana, P., Barner-Kowollik, C., Davis, T. P. and Matyjaszewski, K. 2003. Radical Polymerization Encyclopedia of Polymer Science and Technology; van Herk, A. and Heuts, H. 2009. Emulsion Polymerization. Encyclopedia of Polymer Science and Technology; D.C. Blackley, in High Polymer Latices, vol. 1, page 35 ff. (1966); H. Warson, The Applications of Synthetic Resin Emulsions, chapter 5, page 246 ff. (1972); D. Diederich, Chemie in unserer Zeit [Chemistry in our time], 24, pages 135 to 142 (1990); Emulsion Polymerisation, Interscience Publishers, New York (1965); DE-A-40 03 422 and Dispersionen synthetischer Hochpolymerer [Dispersions of synthetic high polymers], F. Hölscher, Springer-Verlag, Berlin, page 35 ff. (1969).

Polyurethanes, melamine-formaldehyde resins, phenol-formaldehyde resins, urea-formaldehyde resins, melamine-urea-formaldehyde resins, melamine-urea-phenol-formaldehyde resins, urea-glyoxal resins can be obtained by polycondensation by generally known processes, as are known for example from Ullmann's Encyclopedia of Industrial Chemistry, sixth completely revised edition, Wiley-VCH Verlag GmbH Co. KGaA, Weinheim, “Amino Resins”, vol. 2, pages 537 to 565 (2003) for melamine-formaldehyde resins, phenol-formaldehyde resins, urea-formaldehyde resins, melamine-urea-formaldehyde resins, melamine-urea-phenol-formaldehyde resins, urea-glyoxal resins or DE-A-10161156 for polyurethanes.

Particularly preferred binders are the Acronal®, Acrodur®, Emuldur® or Luphen® brands from BASF SE.

Aqueous binder composition based on polymers which have been obtained by free-radical polymerization of ethylenically unsaturated compounds (monomers) comprising in general as essential binder components
i. at least one polymer P, composed of
   ≧0.1 and ≦15% by weight of at least one acid-group-containing ethylenically unsaturated monomer and/or at least one α,β-monoethylenically unsaturated C₃- to C₆-mono- or dicarboxamide (monomers A)
   ≧8 and ≦30% by weight of at least one ethylenically unsaturated carbonitrile or dinitrile (monomers B)
   ≧0 and ≦5% by weight of at least one crosslinking monomer with at least two nonconjugated ethylenically unsaturated groups (monomers C)
   ≧0 and ≦10% by weight of at least one monoethylenically unsaturated silane-group-containing compound (monomers D)
   ≧20 and ≦70% by weight of at least one ethylenically unsaturated monomer, the homopolymer of which has a glass transition temperature of ≧30° C. (monomers E) and which differs from monomers A to D, and
   ≧25 and ≦71.9% by weight of at least one ethylenically unsaturated monomer, the homopolymer of which has a glass transition temperature of ≧50° C. (monomers F) and which differs from monomers A to D,
   in polymerized-in form, where the amounts of monomers A to F add up to 100% by weight, and
ii. at least one saccharide compound S, its amount being such that it is ≧10 and ≦400 parts by weight per 100 parts by weight of polymer P, and
   where the total amount of additional formaldehyde-containing binder components is ≦50 parts by weight per 100 parts by weight of the sum of the total amounts of polymer P and saccharide compound S.

An essential constituent of the aqueous binder composition is a polymer P, which is composed, in polymerized-in form, of
≧0.1 and ≦15% by weight of at least one acid-group-containing ethylenically unsaturated monomer and/or at least one α,β-monoethylenically unsaturated C₃- to C₆-mono- or dicarboxamide (monomers A)
≧8 and ≦30% by weight of at least one ethylenically unsaturated carbonitrile or -dinitrile (monomers B)
≧0 and ≦5% by weight of at least one crosslinking monomer with at least two nonconjugated ethylenically unsaturated groups (monomers C)
≧0 and ≦10% by weight of at least one monoethylenically unsaturated silane-group-containing compound (monomers D)
≧20 and ≦70% by weight of at least one ethylenically unsaturated monomer, the homopolymer of which has a glass transition temperature of ≦30° C. (monomers E) and which differs from monomers A to D, and
≧25 and ≦71.9% by weight of at least one ethylenically unsaturated monomer, the homopolymer of which has a glass transition temperature of ≧50° C. (monomers F) and which differs from monomers A to D.

Suitable monomers A are all ethylenically unsaturated compounds which have at least one acid group [proton donor], such as, for example, a sulfonic acid, phosphonic acid or carboxylic acid group, such as, for example, vinylsulfonic acid, allylsulfonic acid, styrenesulfonic acid, 2-acrylamidomethylpropanesulfonic acid, vinylphosphonic acid, allylphosphonic acid, styrenephosphonic acid and 2-acrylamido-2-methylpropanephosphonic acid. However, the monomers A are advantageously α,β-monoethylenically unsaturated, in particular C₃- to preferably C₃- or C₄-mono- or dicarboxylic acids such as, for example, acrylic acid, methacrylic acid, ethylacrylic acid, itaconic acid, allylacetic acid, crotonic acid, vinylacetic acid, fumaric acid, maleic acid, 2-methylmaleic acid. However, the monomers A also comprise the anhydrides of corresponding α,β-monoethylenically unsaturated dicarboxylic acids, such as, for example, maleic anhydride or 2-methylmaleic anhydride. Preferably, the acid-group-containing monomer A is selected from the group comprising acrylic acid, methacrylic acid, crotonic acid, fumaric acid, maleic acid, maleic anhydride, 2-methylmaleic acid and itaconic acid, with acrylic acid, methacrylic acid and/or itaconic acid being particularly preferred. The monomers A also of course comprise the completely or partially neutralized water-soluble salts, in particular the alkali metal or ammonium salts, of the aforementioned acids.

Suitable monomers A moreover are all α,β-monoethylenically unsaturated C₃- to C₆-mono- or dicarboxamides. The monomers A likewise include the aforementioned compounds, whose carboxamide group is substituted with an alkyl or a methylol group. Examples of such monomers A are the amides and diamides of the α,β-monoethylenically unsaturated C₃- to C₆-, preferably C₃- or C₄-mono- or dicarboxylic acids such as, for example, acrylamide, methacrylamide, ethylacrylic acid amide, itaconic acid mono- or diamide, allylacetic acid amide, crotonic acid mono- or diamide, vinylacetic acid amide, fumaric acid mono- or diamide, maleic acid mono- or diamide, and 2-methylmaleic acid mono- or diamide. Examples of α,β-monoethylenically unsaturated C₃- to C₆-mono- or dicarboxylic acid amides whose carboxylic acid amide group is substituted with an alkyl or a methylol group are N-alkylacrylamides and -methacrylamides, such as, for example, N-tert-butylacrylamide and -methacrylamide, N-methylacrylamide and -methacrylamide, and N-methylolacrylamide and N-methylolmethacrylamide. Preferred amidic monomers A are acrylamide, methacrylamide, N-methylolacrylamide and/or N-methylolmethacrylamide, with methylolacrylamide and/or N-methylolmethacrylamide being particularly preferred.

Monomers A are particularly preferably acrylic acid, methacrylic acid, crotonic acid, fumaric acid, maleic acid, maleic anhydride, 2-methylmaleic acid, itaconic acid, acrylamide, methacrylamide, N-methylolacrylamide and/or N-methylolmethacrylamide, with acrylic acid, methacrylic acid, itaconic acid, methylolacrylamide and/or N-methylolmethacrylamide being particularly preferred.

The amount of monomers A polymerized in the polymer P is ≧0.1 and ≦15% by weight, preferably ≧0.5 and ≦10% by weight and particularly preferably ≧3 and ≦8.5% by weight.

Suitable monomers B are all ethylenically unsaturated compounds which have at least one nitrile group. However, the monomers B are advantageously the nitriles, which are derived from the aforementioned α,β-monoethylenically unsaturated, in particular C₃- to C₆-, preferably C₃- or C₄-mono- or dicarboxylic acids, such as, for example, acrylonitrile, methacrylonitrile, maleic acid dinitrile and/or fumaric acid dinitrile, with acrylonitrile and/or methacrylonitrile being particularly preferred.

The amount of monomers B polymerized in the polymer P is ≧8 and ≦30% by weight, preferably ≧10 and ≦25% by weight and particularly preferably ≧10 and ≦20% by weight.

Suitable monomers C are all compounds which have at least two nonconjugated ethylenically unsaturated groups. Examples thereof are monomers having two vinyl radicals, monomers having two vinylidene radicals, and monomers having two alkenyl radicals. Of particular advantage here are the diesters of dihydric alcohols with α,β-monoethylenically unsaturated monocarboxylic acids, among which acrylic acid and methacrylic acid are preferred. Examples of such monomers having two nonconjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylate and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate, triesters of trihydric alcohols with α,β-monoethylenically unsaturated monocarboxylic acids, such as, for example, glycerol triacrylate, glycerol trimethacrylate, trimethylolpropane triacrylate, trimethylolpropane trimethacrylate, and divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate or triallyl isocyanurate. Particular preference is given to 1,4-butylene glycol diacrylate, allyl methacrylate and/or divinylbenzene.

The amount of monomers C polymerized in the polymer P is ≧0 and ≦5% by weight, preferably ≧0 and ≦3% by weight and particularly preferably ≧0 and ≦1.5% by weight.

Suitable monomers D are all monoethylenically unsaturated silane-group-containing compounds. With particular advantage, the monomers D have a hydrolyzable silane group. Hydrolyzable silane groups advantageously comprise at least one alkoxy group or one halogen atom, such as, for example, chlorine. Monomers D that can be used advantageously are disclosed in WO-A-2008/150647, page 9, lines 5 to 25. 3-Methacryloxypropyltrimethoxysilane, 3-methacryloxypropyltriethoxysilane, vinyltriacetoxysilane and/or vinylethoxydimethoxysilane are used particularly advantageously. In this connection, the monomers D are always preferably used if inorganic granular and/or fibrous substrates, such as in particular glass fibers or mineral fibers, for example, asbestos or rock wool, are to be bonded.

The amount of monomers D optionally polymerized in the polymer P is, in a preferred embodiment, ≧0 and ≦10% by weight, preferably ≧0 and ≦5% by weight and particularly preferably 0% by weight. In another preferred embodiment, particularly if inorganic granular and/or fibrous substrates are to be bonded, the amount of monomers D polymerized in the polymer P is ≧0.1 and ≦10% by weight, advantageously ≧0.1 and ≦5% by weight and particularly advantageously ≧0.5 and ≦2.5% by weight.

Suitable monomers E are all ethylenically unsaturated monomers whose homopolymer has a glass transition temperature ≦30° C. and which differ from monomers A to D. Suitable monomers E are, for example, conjugated aliphatic C₄- to C₉-diene compounds, esters of vinyl alcohol and a C₁- to C₁₀-monocarboxylic acid, C₁- to C₁₀-alkyl acrylate, C₅- to C₁₀-alkyl methacrylate, C₅- to C₁₀-cycloalkyl acrylate and methacrylate, C₁- to C₁₀-dialkyl maleate and/or C₁- to C₁₀-dialkyl fumarate, vinyl ethers of C₃- to C₁₀-alkanols, branched and unbranched C₃- to C₁₀-olefins. Those monomers E whose homopolymers have Tg values <0° C. are advantageously used. The monomers E used are particularly advantageously vinyl acetate, ethyl acrylate, n-propyl acrylate, n-butyl acrylate, isobutyl acrylate, sec-butyl acrylate, n-hexyl acrylate, 2-ethylhexyl acrylate, n-hexyl methacrylate, 2-ethylhexyl methacrylate, di-n-butyl maleate, di-n-butyl fumarate, with 2-ethylhexyl acrylate, n-butyl acrylate, 1,4-butadiene and/or ethyl acrylate being particularly preferred.

The amount of monomers E polymerized in the polymer P is ≧20 and ≦70% by weight, preferably ≧25 and ≦65% by weight and particularly preferably ≧30 and ≦60% by weight.

Suitable monomers F are all ethylenically unsaturated monomers whose homopolymer has a glass transition temperature ≧50° C. and which differ from monomers A to D. Suitable monomers F are, for example, vinylaromatic monomers and C₁- to C₄-alkyl methacrylates. Vinylaromatic monomers are understood as meaning in particular derivatives of styrene or of α-methylstyrene, in which the phenyl rings are optionally substituted by 1, 2 or 3 C₁- to C₄-alkyl groups, halogen, in particular bromine or chlorine, and/or methoxy groups. Preference is given to those monomers whose homopolymers have a glass transition temperature ≧80° C. Particularly preferred monomers are styrene, α-methylstyrene, o- or p-vinyltoluene, p-acetoxystyrene, p-bromostyrene, p-tert-butylstyrene, o-, m- or p-chlorostyrene, methyl methacrylate, tert-butyl acrylate, tert-butyl methacrylate, ethyl methacrylate, isobutyl methacrylate, n-hexyl acrylate, cyclohexyl methacrylate, but, for example, also tert-butyl vinyl ether or cyclohexyl vinyl ether, but with methyl methacrylate, styrene and/or tert-butyl methacrylate being particularly preferred.

The amount of monomers F polymerized in the polymer P is ≧25 and ≦71.9% by weight, preferably ≧25 and ≦64.5% by weight and particularly preferably ≧25 and ≦57% by weight.

Aqueous binder composition comprising a polyurethane composed of
1a) diisocyanates,
1b) diols, of which
   1b₁) 10 to 100 mol %, based on the total amount of diols (1 b), have a molecular weight of from 500 to 5000, and
   1b₂) 0 to 90 mol %, based on the total amount of diols (1 b), have a molecular weight of from 60 to 500 g/mol,
1c) monomers that are different from monomers (1a) and (1b) and have at least one isocyanate group or at least one group that is reactive towards isocyanate groups, and which moreover carry at least one hydrophilic group or one potentially hydrophilic group, as a result of which the dispersability of the polyurethanes in water is effected,
1d) optionally further polyvalent compounds that are different from monomers (1a) to (1c) and have reactive groups which are alcoholic hydroxyl groups, primary or secondary amino groups or isocyanate groups and
1e) optionally monovalent compounds that are different from monomers (1a) to (1d) and have a reactive group which is an alcoholic hydroxyl group, a primary or secondary amino group or an isocyanate group,
   obtainable by reacting monomers 1a), 1b), 1c) and optionally 1d) and 1e) in the presence of a suitable catalyst.

The aqueous dispersions comprise polyurethanes which are derived from diisocyanates 1a) as well as other monomers, preference being given to using those diisocyanates 1a) which are usually used in polyurethane chemistry.

As monomers, mention is to be made in particular of
1a) diisocyanates X(NCO)₂, where X is an aliphatic hydrocarbon radical having 4 to 12 carbon atoms, a cycloaliphatic or aromatic hydrocarbon radical having 6 to 15 carbon atoms or an araliphatic hydrocarbon radical having 7 to 15 carbon atoms. Examples of such diisocyanates are tetramethylene diisocyanate, hexamethylene diisocyanate (HDI), dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)propane, trimethylhexane diisocyanate, 1,4-diisocyanatobenzene, 2,4-diisocyanatotoluene, 2,6-diisocyanatotoluene, 4,4′-diisocyanatodiphenylmethane, 2,4′-diisocyanatodiphenylmethane, p-xylylene diisocyanate, tetramethylxylylene diisocyanate (TMXDI), the isomers of bis(4-isocyanatocyclohexyl)methane (HMDI) such as the trans/trans, cis/cis and cis/trans isomers, and mixtures consisting of these compounds.

Diisocyanates of this type are commercially available.

Important mixtures of these isocyanates are particularly the mixtures of the respective structural isomers of diisocyanatotoluene and diisocyanatodiphenylmethane, the mixture of 80 mol % of 2,4-diisocyanatotoluene and 20 mol % of 2,6-diisocyanatotoluene being particularly suitable. Furthermore, the mixtures of aromatic isocyanates such as 2,4-diisocyanatotoluene and/or 2,6-diisocyanatotoluene with aliphatic or cycloaliphatic isocyanates such as hexamethylene diisocyanate or IPDI are particularly advantageous, in which case the preferred mixing ratio of the aliphatic to aromatic isocyanates is 4:1 to 0.25:1.

For building up the polyurethanes, compounds that can be used apart from those mentioned above are also isocyanates which, besides the free isocyanate groups, carry further capped isocyanate groups, e.g. uretdione groups.

As regards good film formation and elasticity, suitable diols are
1b) primarily higher molecular weight diols (b₁) which have a molecular weight of from 500 to 5000 g/mol, preferably from 1000 to 3000 g/mol.

The diols (1b₁) are in particular polyester polyols which are known, e.g. from Ullmann's Encyclopedia of Industrial Chemistry, 4th edition, volume 19, pages 62 to 65. Preference is given to using polyester polyols which are obtained by reacting dihydric alcohols with dibasic carboxylic acids. Instead of the free polycarboxylic acids, it is also possible to use the corresponding polycarboxylic anhydrides or corresponding polycarboxylic acid esters of lower alcohols or mixtures thereof for preparing the polyester polyols. The polycarboxylic acids may be aliphatic, cycloaliphatic, araliphatic, aromatic or heterocyclic and be optionally e.g. halogen-substituted and/or unsaturated. Examples thereof include: suberic acid, azelaic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimeric fatty acids. Preference is given to dicarboxylic acids of the general formula HOOC—(CH₂)_{y}—COOH, where y is a number from 1 to 20, preferably an even number from 2 to 20, e.g. succinic acid, adipic acid, sebacic acid and dodecanedicarboxylic acid.

Suitable polyhydric alcohols are e.g. ethylene glycol, propane-1,2-diol, propane-1,3-diol, butane-1,3-diol, butene-1,4-diol, butyne-1,4-diol, pentane-1,5-diol, neopentyl glycol, bis(hydroxymethyl)cyclohexanes such as 1,4-bis(hydroxymethyl)cyclohexane, 2-methylpropane-1,3-diol, methylpentane diols, also diethylene glycol, triethylene glycol, tetraethylene glycol, polyethylene glycol, dipropylene glycol, polypropylene glycol, dibutylene glycol and polybutylene glycols. Preference is given to alcohols of the general formula HO—(CH₂)ₓ—OH, where x is a number from 1 to 20, preferably an even number from 2 to 20. Examples thereof are ethylene glycol, butane-1,4-diol, hexane-1,6-diol, octane-1,8-diol and dodecane-1,12-diol. Furthermore, preference is given to neopentyl glycol.

Of suitability are furthermore also polycarbonate diols, as can be obtained e.g. by reacting phosgene with an excess of the low molecular weight alcohols specified as structural components for the polyester polyols.

Also of suitability are polyester diols based on lactone, which are homopolymers or mixed polymers of lactones, preferably addition products having terminal hydroxyl groups, of lactones onto suitable difunctional starter molecules. Suitable lactones are preferably those which are derived from compounds of the general formula HO—(CH₂)_{z}—COOH, where z is a number from 1 to 20 and an H atom of a methylene unit can also be substituted by a C₁- to C₄-alkyl radical. Examples are ε-caprolactone, β-propiolactone, γ-butyrolactone and/or methyl-ε-caprolactone, and mixtures thereof. Suitable starter components are, e.g. the low molecular weight dihydric alcohols specified above as structural component for the polyester polyols. The corresponding polymers of 8-caprolactone are particularly preferred. Lower polyester diols or polyether diols can also be used as starters for preparing the lactone polymers. Instead of the polymers of lactones, it is also possible to use the corresponding, chemically equivalent polycondensates of the hydroxycarboxylic acids corresponding to the lactones.

In addition, suitable monomers (1b₁) are polyether diols. They are obtainable in particular by polymerization of ethylene oxide, propylene oxide, butylene oxide, tetrahydrofuran, styrene oxide or epichlorohydrin with themselves, e.g. in the presence of BF₃ or as a result of the addition of these compounds optionally in the mixture, or successively, onto starting components with reactive hydrogen atoms, such as alcohols or amines, e.g. water, ethylene glycol, propane-1,2-diol, propane-1,3-diol, 1,2-bis(4-hydroxydiphenyl)propane or aniline. Particular preference is given to polytetrahydrofuran with a molecular weight of from 240 to 5000, and in particular 500 to 4500. In addition, mixtures of polyester diols and polyether diols can also be used as monomers (1b₁).

Likewise of suitability are polyhydroxy olefins, preferably those with 2 terminal hydroxyl groups, e.g. α-ω-dihydroxypolybutadiene, α-ω-dihydroxypolymethacrylate or α-ω-dihydroxypolyacrylate as monomers (1c₁). Such compounds are known, for example, from EP-A-622378. Further suitable polyols are polyacetals, polysiloxanes and alkyd resins.

The polyols can also be used as mixtures in the ratio 0.1:1 to 9:1.

The monomers (1b₂) used are primarily the structural components of the short-chain alkane diols specified for the preparation of polyester polyols, preference being given to diols having 2 to 12 carbon atoms, unbranched diols having 2 to 12 carbon atoms and an even number of carbon atoms, and pentane-1,5-diol and neopentyl glycol.

Preferably, the fraction of the diols (1b₁), based on the total amount of diols (1b), is 10 to 100 mol % and the fraction of the monomers (b₂), based on the total amount of the diols (1b), is 0 to 90 mol %. Particularly preferably, the ratio of the diols (1b₁) to the monomers (1b₂) is 0.1:1 to 5:1, particularly preferably 0.2:1 to 2:1.

In order to achieve the dispersability of the polyurethanes in water, the polyurethanes are composed, besides components (1a), (1b) and optionally (1d), of monomers (1c) that are different from components (1a), (1b) and (1d), and which carry at least one isocyanate group or at least one group that is reactive toward isocyanate groups and moreover at least one hydrophilic group or a group which can be converted to a hydrophilic group. Hereinbelow, the term “hydrophilic groups or potentially hydrophilic groups” is abbreviated to “(potentially) hydrophilic groups”. The (potentially) hydrophilic groups react with isocyanates considerably more slowly than the functional groups of the monomers which serve for constructing the polymer main chain.

The fraction of the components with (potentially) hydrophilic groups of the total amount of components (1a), (1b), (1c), (1d) and (1e) is generally such that the molar amount of the (potentially) hydrophilic groups, based on the amount by weight of all monomers (1a) to (1e), is 30 to 1000 mmol/kg, preferably 50 to 500 mmol/kg and particularly preferably 80 to 300 mmol/kg.

(Potentially) ionic monomers (1c) are described in detail e.g. in Ullmann's Encyclopedia of Industrial Chemistry, 4th edition, volume 19, pages 311 to 313 and for example in DE-A-14 95 745.

Of particular practical importance as (potentially) cationic monomers (1c) are, in particular, monomers with tertiary amino groups, for example: tris(hydroxyalkyl)amines, N,N′-bis(hydroxyalkyl)alkylamines, N-hydroxyalkyl-1-dialkylamines, tris(aminoalkyl)amines, N,N′-bis(aminoalkyl)alkylamines, N-aminoalkyldialkylamines, where the alkyl radicals and alkanediyl units of these tertiary amines consist independently of one another of 1 to 6 carbon atoms. Also of suitability are polyethers having tertiary nitrogen atoms and preferably two terminal hydroxyl groups, as are accessible e.g. by alkoxylation of amines having two hydrogen atoms bonded to amine nitrogen, e.g. methylamine, aniline or N,N′-dimethylhydrazine, in a manner customary per se. Polyethers of this type generally have a molar weight between 500 and 6000 g/mol.

These tertiary amines are converted to the ammonium salts either with acids, preferably strong mineral acids such as phosphoric acid, sulfuric acid, hydrohalic acids, or strong organic acids, or by reaction with suitable quaternizing agents such as C₁- to C₆-alkyl halides or benzyl halides, e.g. bromides or chlorides.

Suitable monomers with (potentially) anionic groups are usually aliphatic, cycloaliphatic, araliphatic or aromatic carboxylic acids and sulfonic acids which carry at least one alcoholic hydroxyl group or at least one primary or secondary amino group. Preference is given to dihydroxyalkylcarboxylic acids, primarily having 3 to 10 carbon atoms, as are also described in U.S. Pat. No. 3,412,054.

Otherwise of suitability are dihydroxyl compounds with a molecular weight above 500 to 10 000 g/mol with at least 2 carboxylate groups which are known from DE-A-39 11 827. They are obtainable by reacting dihydroxyl compounds with tetracarboxylic dianhydrides such as pyromellitic dianhydride or cyclopentanetetracarboxylic dianhydride in the molar ratio 2:1 to 1.05:1 in a polyaddition reaction. Suitable dihydroxyl compounds are in particular the monomers (1b₂) and the diols (1b₁) listed as chain extenders.

Suitable monomers (1c) with amino groups that are reactive toward isocyanates are aminocarboxylic acids such as lysine, β-alanine or the adducts, given in DE-A-20 34 479, of aliphatic diprimary diamines onto α,β-unsaturated carboxylic acids or sulfonic acids.

Particular preference is given to N-(2-aminoethyl)-2-aminoethanecarboxylic acid and N-(2-aminoethyl)-2-aminoethanesulfonic acid or the corresponding alkali metal salts, with Na being particularly preferred as counterion.

Furthermore, preference is given to the adducts of the aforementioned aliphatic diprimary diamines onto 2-acrylamido-2-methylpropanesulfonic acid, as described, e.g. in the DE patent specification 19 54 090.

The polyurethanes comprise preferably 1 to 30, particularly preferably 4 to 25 mol %, based on the total amount of components (1b) and (1d) of a polyamine with at least 2 amino groups that are reactive toward isocyanates as monomers (1d).

Monomers (1e), which are optionally co-used, are monoisocyanates, monoalcohols and monoprimary and monosecondary amines. In general, their fraction is at most 10 mol %, based on the total molar amount of the monomers. These monofunctional compounds usually carry further functional groups such as olefinic groups or carbonyl groups and serve for introducing functional groups into the polyurethane, which permit the dispersion and/or the crosslinking or other polymer-analogous reaction of the polyurethane. Of suitability for this are monomers such as isoprenyl α,α-dimethylbenzylisocyanate (TMI) and esters of acrylic acid or methacrylic acid such as hydroxyethyl acrylate or hydroxyethyl methacrylate.

Normally, the components (1a) to (1e) and their respective molar amounts are selected such that the ratio A:B is 0.5:1 to 2:1, preferably 0.8:1 to 1.5:1, particularly preferably 0.9:1 to 1.2:1. Very particularly preferably, the ratio A:B is as close as possible to 1:1, in which

A) means the molar amount of isocyanate groups and
B) means the sum of the molar amount of hydroxyl groups and the molar amount of functional groups which can react with isocyanates in an addition reaction.

The monomers (1a) to (1e) used carry on average usually 1.5 to 2.5, preferably 1.9 to 2.1, particularly preferably 2, isocyanate groups or functional groups which can react with isocyanates in an addition reaction.

The polyaddition of monomers 1a), 1 b), 1c) and optionally 1d) and 1e) for preparing the PU dispersion takes place in the presence of a suitable catalyst.

Suitable catalysts are tin compounds, for example dibutyltin dilaurate, also tertiary amines, and compounds of iron, zinc, zirconium, copper, bismuth, titanium, molybdenum, and cesium.

Q. Bell, Raw Materials and their Usage, in: Solvent-Borne Urethane Resins, Vol. 1:Surface Coatings, Chapman and Hall, New York, 1993, p. 153 ff., describes various aminic and metal-based catalysts.

Preferred cesium compounds are cesium salts, in which the following anions are used: F, Cl⁻, ClO⁻, ClO₃, ClO₄, Br⁻, J⁻, JO₃_{^{−}}, CN⁻, OCN⁻, NO₂_{^{−}}, NO₃_{^{−}}, HCO₃_{^{−}} CO₃_{^{2−}}, S²⁻, SH⁻, HSO₃_{^{−}}, SO₃_{^{2−}}, HSO₄_{^{−}}, S₂O₂²⁻, S₂O₄_{^{2−}}, S₂O₅_{^{2−}}, S₂O₆_{^{2−}}, S₂O₇_{^{2−}}, S₂O₈_{^{2−}}, H₂PO₂_{^{−}}, H₂PO₄_{^{−}}, HPO₄_{^{−}}, PO₄_{^{3−}}, P₂P₇_{^{4−}}, (OCₙH₂ₙ₊₁)⁻, (CₙH₂ₙ₋₁O₂)⁻, (Cₙ₊₁H₂ₙ₋₂O₄)²⁻, where n is numbers 1 to 20.

Particular preference is given to here to cesium carboxylates in which the anion obeys the formulae (CₙH₂ₙ₋₁O₂)⁻ and (Cₙ₊₁H₂ₙ₋₂O₄)²⁻ where n is 1 to 20. Very particularly preferred cesium salts have, as anions, monocarboxylates of the general formula (CₙH₂ₙ₋₁O₂)⁻, where n is numbers 1 to 20. Particular mention should be made here of formate, acetate, propionate, hexanoate and 2-ethylhexanoate.

The cesium salts are used in amounts of from 0.01 to 10 mmol of cesium salt per kg of solvent-free mixture. Preferably, they are used in amounts of from 0.05 to 2 mmol of cesium salt per kg of solvent-free mixture.

The dispersions generally have a solids content of from 10 to 75, preferably from 20 to 65% by weight and a viscosity of from 10 to 500 mPas (measured at a temperature of 20° C. and a shear rate of 250 s⁻¹).

Such aqueous polyurethane dispersions are described, for example in DE-A-101 61 156.

The aqueous solution or dispersion of a precondensate of a heat-curable resin and of a binder can optionally also comprise a surfactant. Of suitability are, for example, nonionic, anionic and cationic surfactants, and mixtures of at least one nonionic and at least one anionic surfactant, mixtures of at least one nonionic and at least one cationic surfactant, mixtures of two or more nonionic or of two or more cationic or of two or more anionic surfactants.

The flexible foams according to the invention can be produced as follows:

The foams can be firstly treated with an aqueous solution or dispersion of a precondensate of at least one heat-curable resin and a binder.

The solution or dispersion of the precondensate and of the binder can comprise a curing agent, but can also be used without curing agents.

Processes for producing flexible foams with an abrasive surface can be carried out by applying an aqueous solution or dispersion of at least one precondensate of a heat-curable resin and of the binder to the top and/or bottom of a flexible foam in an amount in the range from 0.1 to 90% by weight, based on the uncoated, dry foam, then crosslinking the precondensate and drying the treated foam.

In a highly suitable process, dyes or pigments are added to the finished aqueous solution or dispersion of the precondensate before it is applied to the foam.

In a further highly suitable process, the dyes or pigments are added during the preparation of the aqueous solution or dispersion of the precondensate, and said solution or dispersion is then applied to the foam.

In a further highly suitable process, dyes or pigments are added during the preparation of the precondensate. Then, only shortly before application is this mixture converted to an aqueous solution or dispersion and then applied to the foam.

In order to achieve a good and as uniform as possible distribution of the resin and of the binder, preferably on the surface of the substrate and not in its deeper layers, during the resin application, a certain rheological behavior or a certain viscosity of the aqueous solution or dispersion of the precondensate is advantageous. The aqueous solution or dispersion of the precondensate and of the binder should be liquid enough to allow it to be easily spread out on the substrate, but not so liquid that it rapidly penetrates or is soaked into the deeper layers of the substrate upon spreading.

Furthermore, it is advantageous to achieve a good and as uniform as possible distribution of the aqueous solution or dispersion of the precondensate and of the binder on the corresponding resin application devices, for example pressure rollers, doctor blade or sieve, in order to ensure an even transfer of the aqueous solution or dispersion of the precondensate on the foam.

Furthermore, it is advantageous to establish a suitable viscosity of the aqueous solution or dispersion of the precondensate and of the binder so that, upon application of the aqueous solution or dispersion of the precondensate and of the binder using the spray method, the drop size of the precondensate is as small as possible, the drops do not block the spray nozzle and are spread evenly on the foam.

The aqueous solution or dispersion of the precondensate and of the binder therefore comprises a polymeric thickener in the range from 0 to 10% by weight, preferably in the range from 0 to 5% by weight, based on the aqueous solution or dispersion of the precondensate.

In order to prepare the products according to the invention, the solution or dispersion of the precondensate (also referred to below as “preparation solution”) can be applied to the foam either over the whole area or else in the form of a pattern. The viscosity of the preparation solution, i.e. of the aqueous solution or dispersion of the precondensate and of the binder with or without curing agent, is usually adjusted by adding the thickeners according to the invention and then applied to the substrate and only then cured.

The preparation solution according to the invention is preferably applied to the foam by spraying, knife coating, rolling, printing, inter alia with screen printing, or with the help of other suitable technical equipment known to the person skilled in the art, such as e.g. a sizing press, a film press, an airbrush, a unit for curtain coating. Preferably, contactless processes or processes with as low a pressure as possible on the flat substrate are employed, such as spraying, in order to reduce the absorption of the resin into the substrate.

Application can be to one or both sides, either simultaneously or in succession. The amount of curable resin which is applied to the flat substrate with the help of the preparation solution is for example 1 to 90% by weight, preferably 1 to 85% by weight, in particular 1 to 80% by weight, based on the areal weight of the uncoated dry foam.

After applying the preparation solution to the flat substrate, the crosslinking of the heat-curable resin and of the binder and the drying of the foams provided with a coating of a precondensate of a heat-curable resin and of the the binder are carried out, it being possible for crosslinking and drying to run simultaneously or in succession. One advantageous embodiment consists in crosslinking the heat-curable resin and the binder in a moist atmosphere and then drying the product. The thermal curing of the resins and the drying of the products can take place for example in the temperature range from 20 to 250° C., preferably 20 to 200° C., particularly preferably 20 to 150° C.

The drying step can be performed for example also in gas driers or in IR driers. The higher the temperature employed in each case, the shorter the residence time of the material to be dried in the drying equipment. If desired, the product according to the invention can also be tempered at temperatures up to 300° C. after drying. Temperatures above 300° C. can also be used for curing the resin, although the required residence times are then very short.

Sizes and impregnating resins which are each sold as aqueous binders or powders based on condensates of urea, melamine and formaldehyde as Kauramin® and Kaurit® from BASF SE, are used in the furniture and construction industry for producing plate-like wood products such as chipboard, sheets of plywood and covering boards, cf. technical information on Kaurit®. Papers impregnated with impregnating resins have a hard surface. Such products can be found, for example, in surfaces of laminate floorings, or in the decoration of furniture, cf. technical information on Kauramin®.

Flexible, abrasive foams are obtained which are used for the cleaning of surfaces in the home and in industry. They are particularly suitable as abrasive foams which are used for machine and manual floor cleaning.

Upon wiping surfaces made of glass, metal or plastic, the foams according to the invention develop a scouring effect which is desired for cleaning these surfaces. In this connection, however, the scouring effect is much less than that for the cleaning foams provided with abrasive particles, meaning that the substrates according to the invention are suitable for all applications in which only a slight scouring effect is desired for removing dirt, meaning that the surface of the materials wiped with the foams according to the invention is practically not damaged or scratched.

The percentages in the examples are percentages by weight, unless the context suggests otherwise.

### EXAMPLES

### Preparation Solution 1

A methanol-etherified precondensate of melamine and formaldehyde (Saduren® 163, BASF SE) was used to prepare an aqueous solution by mixing 57 ml of completely demineralized water with 43 g of precondensate solution and 0.9 g of p-toluenesulfonic acid.

### Preparation Solution 2

A precondensate of melamine and formaldehyde (Kauramin® KMT 773, BASF SE) was used to prepare a 30% strength aqueous solution by mixing 175 ml of completely demineralized water with 75 g of impregnating resin powder.

### Preparation Solution 3

8.6 g of an aqueous polyurethane dispersion (Emuldur® 360 A, BASF SE) is mixed with 11.4 g of completely demineralized water and 2.6 g of a methanol-etherified precondensate of melamine and formaldehyde (Saduren® 163, BASF SE).

### Preparation Solution 4

45 g of an aqueous dispersion of a copolymer of acrylic acid esters and acrylonitrile (Acronal® 32 D, BASF SE) is mixed with 7 g of a methanol-etherified precondensate of melamine and formaldehyde (Saduren® 163, BASF SE).

### Example 1

### Coating of Flexible Foams by Spraying, 2 Spraying Operations

A flexible polyester-polyurethane foam measuring 15×22 cm was sprayed with some of preparation solution 1 using a spray gun and then dried for 5 min at 80° C. Then, 30 g of preparation solution 2 were mixed with 0.9 g of concentrated formic acid and the solution resulting therefrom was sprayed onto the previously generated coating using a spray gun. The sample body is then dried in a drying cabinet for 15 min at 80° C. The foam body was then dry and crosslinked. The total application on the foam was 212 g/m² after drying.

### Example 2

### Coating of Flexible Foams by Spraying, 2 Spraying Operations

Firstly, some of preparation solution 3 was sprayed onto a flexible polyester-polyurethane foam measuring 10×10 cm using a spray gun. Then 30 g of preparation solution 2 were mixed with 0.9 g of concentrated formic acid and the solution resulting therefrom was sprayed onto the previously generated layer using a spray gun. The sample body is then dried in a drying cabinet for 15 min at 80° C. The foam body was then dry and crosslinked.

### Example 3

### Coating of Flexible Foams by Spraying, 1 Spraying Operation

Preparation solution 3 is admixed with 20 g of preparation solution 2 and 0.6 g of concentrated formic acid and the solution resulting therefrom is sprayed onto a flexible polyester-polyurethane foam measuring 15×22 cm using a spray gun. The sample body is then dried in a drying cabinet for 15 min at 80° C. The foam body was then dry and crosslinked. The total application to the foam was 135 g/m² after drying.

### Example 2

### Coating of Flexible Foams by Spraying, 2 Spraying Operations

A flexible polyester-polyurethane foam measuring 10×10 cm was firstly sprayed with some of preparation solution 4 using a spray gun and then dried for 5 min at 110° C. Then, 30 g of preparation solution 2 were mixed with 0.9 g of concentrated formic acid and the solution resulting therefrom was sprayed onto the previously generated layer using a spray gun. The sample body is then dried in a drying cabinet for 15 min at 150° C. Afterwards, the foam body was dry and crosslinked.

### Assessing the Adhesion

The coated foams obtained according to the examples were tested as to adhesion of the coating at the coated sites. For this, a piece measuring 2.5 cm×2.5 cm was cut out of the test body from the samples. This test body was then held above black paper at a distance of ca 5-10 cm, and the adhesion of the coating was assessed by pressing and rubbing on the coated side of the foam using the thumb of the right hand. The subjective result obtained here was correlated with the amount of dust produced therewith on the black paper underneath. A comparison of the different samples produces a relative impression of the adhesion of the coating (6=extremely poor adhesion; 1=very good adhesion; school grading system).

### Cleaning Effect

The coated papers obtained according to the examples were tested as to their suitability as wiping cloths and compared with standard commercial uncoated papers. For this, the sample to be tested was in each case fixed to one side of a square punch with a side length of 25 mm and a weight of 460 g with the help of an adhesive. A glass plate was attached to a shaking machine (Crockmeter). Several marks were then drawn onto the glass plate using a permanent marker (Permanent Marker Edding 3000). The square punch was placed on this area, with the side of the punch stuck with the sample to be tested positioned in each case on the glass plate. The area of the plate to be cleaned was wetted with 0.5 ml of completely demineralized water. The shaking machine was working at 20 up-and-down strokes/min with a horizontal deflection of the plate of 5 cm. Eight strokes (4 up-and-down strokes) were carried out in the wet and the degree of removal of the markings on the plate was determined. For this, the relative cleaning effect (6=no effect, 1=completely removed, school grading system) was determined compared with reference samples.

The tests carried out and the results obtained are given in the table below.

| | Relative | Relative |
|---|---|---|
| Foam | adhesion | cleaning effect |
| Example 1 | 3 | 3 |
| Example 2 | 2 | 1 |
| Example 3 | 2 | 1 |
| Example 4 | 2 | 2 |
| Without coating | — | 6 |

The invention claimed is:

1.-16. (canceled)

17. A flexible foam with an abrasive surface comprising:
1 to 90% by weight of a mixture, based on an uncoated substrate, the mixture comprising a condensation product of;
99.985 to 20% by weight of at least one precondensate of a heat-curable resin,
0 to 10% by weight of a polymeric thickener selected from the group consisting of a biopolymer, an associative thickener, a completely synthetic thickener, and any one mixture thereof,
0.01 to 10% by weight of a curing agent,
0 to 10% by weight of surface-active substances, surfactants or mixtures thereof,
0 to 15% by weight of dyes, pigments, or mixture thereof, and
0 to 75% by weight of water, and
10 to 70% by weight of one or more binders, based on the above mixture, selected from the group consisting of polyacrylates, polymethacrylates, polyacrylonitriles, polyurethanes, melamine-formaldehyde resins, phenol-formaldehyde resins, urea-formaldehyde resins, melamine-urea-formaldehyde resins, melamine-urea-phenol-formaldehyde resins, urea-glyoxal resins, and any one copolymer of acrylic acid esters and acrylonitrile, styrene and acrylonitrile, acrylic acid esters and styrene and acrylonitrile, acrylonitrile and butadiene and styrene.

18. The flexible foam according to claim 17, wherein the flexible foam is selected from the group consisting of polystyrene, polyvinyl chloride, polyurethane, polyamide, polyester, polyolefin and cellulose foams.

19. The flexible foam according to claim 17, wherein the flexible foam is a polyurethane foam.

20. The flexible foam according to claim 17, wherein the one or more binders are aqueous binders including any one of the polyacrylates, polymethacrylates, polyacrylonitriles, polyurethanes, melamine-formaldehyde resins, phenol-formaldehyde resins, urea-formaldehyde resins, melamine-urea-formaldehyde resins, melamine-urea-phenol-formaldehyde resins, urea-glyoxal resins, and any one copolymer of acrylic acid esters and acrylonitrile, styrene and acrylonitrile, acrylic acid esters and styrene and acrylonitrile, acrylonitrile and butadiene and styrene, or any one mixture thereof.

21. The flexible foam according to claim 17, wherein the at least one precondensate of the heat-curable resins are selected from the group consisting of melamine/formaldehyde precondensates, methanol etherified melamine/formaldehyde precondensates, urea/formaldehyde precondensates, melamine/urea/formaldehyde precondensates, melamine/urea/phenol/formaldehyde precondensates, urea/glyoxal precondensates and phenol/formaldehyde precondensates.

22. The flexible foam according to claim 17, wherein the at least one precondensate heat-curable resin used is a precondensate of melamine and formaldehyde in which the molar ratio of formaldehyde to melamine is 1:1 to 4:1.

23. The flexible foam according to claim 17, wherein a solution or dispersion of the precondensate comprises 0.1 to 10% by weight of the curing agent selected from a group of acids or salts thereof, and an aqueous solution of these salts.

24. The flexible foam according to claim 17, wherein a solution or dispersion of the precondensate comprises 0.001 to 5% by weight of the surfactant, the surface-active substance or the mixture thereof.

25. The flexible foam according to claim 17, wherein a solution or dispersion of the precondensate comprises 0 to 5% by weight of the biopolymer, the associative thickener, the completely synthetic thickener or the mixture thereof.

26. The flexible foam according to claim 17, wherein a solution or dispersion of the precondensate is applied to an entire surface of the substrate.

27. The flexible foam according to claim 17, wherein an aqueous solution or an aqueous dispersion of the precondensate is applied as a pattern to a surface of the substrate.

28. The flexible foam according to claim 17, wherein the foam treated with an aqueous solution of a precondensate is cured and dried at a temperature in a range from 20 to 250° C.

29. The flexible foam according to claim 17, wherein the dyes, pigments or mixture thereof is present from 0 to 10% by weight.

30. The flexible foam according to claim 17 as an abrasive foam for machine and manual floor cleaning.

31. A process for producing flexible foams with an abrasive surface, the process comprising:
applying an aqueous solution or dispersion of the mixture of at least one precondensate of a heat-curable resin to a top and/or bottom surface of a flexible foam in an amount in the range from 0.1 to 90% by weight, based on an uncoated, dry foam;
crosslinking the applied precondensate; and drying the treated foam,
wherein the aqueous solution or dispersion comprises;
99.985 to 20% by weight of the at least one precondensate of a heat-curable resin,
0 to 10% by weight of a polymeric thickener selected from the group consisting of a biopolymer, an associative thickener, a completely synthetic thickener, and any one mixture thereof,
0.01 to 10% by weight of a curing agent,
0 to 10% by weight of surface-active substances, surfactants or mixtures thereof,
0 to 15% by weight of dyes, pigments, or mixture thereof, and
0 to 75% by weight of water, and
10 to 70% by weight of one or more binders, based on the above mixture, selected from the group consisting of polyacrylates, polymethacrylates, polyacrylonitriles, polyurethanes, melamine-formaldehyde resins, phenol-formaldehyde resins, urea-formaldehyde resins, melamine-urea-formaldehyde resins, melamine-urea-phenol-formaldehyde resins, urea-glyoxal resins, and any one copolymer of acrylic acid esters and acrylonitrile, styrene and acrylonitrile, acrylic acid esters and styrene and acrylonitrile, acrylonitrile and butadiene and styrene.
